(19) United States
(12) Patent Application Publication
(10) Pub. No.: US 2017/0254164 A1
(43) Pub. Date: Sep. 7, 2017

(54) INDUCTION HEATER FOR DRILLING CUTTINGS AND OTHER MATERIALS AND METHOD

(71) Applicant: Electric Horsepower Inc., Nisku (CA)

(72) Inventors: Robert FOLK, Edmonton (CA); Adrian Lachance, Red Deer (CA)

(73) Assignee: Electric Horsepower Inc., Nisku (CA)

(21) Appl. No.: 15/452,477

(22) Filed: Mar. 7, 2017

Related U.S. Application Data
(60) Provisional application No. 62/304,897, filed on Mar. 7, 2016.

(51) Int. Cl. E21B 21/06; B02C 4/08; B02C 4/32; F26B 23/04; F26B 3/347; F26B 17/20; F26B 25/00; H05B 6/10; F26B 1/00

(52) U.S. Cl. CPC E21B 21/066; H05B 6/107; B02C 4/08; B02C 4/32; F26B 1/005; F26B 3/347; F26B 17/20; F26B 25/006; F26B 23/04; F26B 2200/18

(57) ABSTRACT

An induction heater and materials processing apparatus and method using induction heating and rotary tumbling to heat or heat and dry materials such as drilling cuttings or waste material.

### CROSS REFERENCE TO RELATED APPLICATIONS

This application claims the benefit of priority of U.S. Provisional Patent Application No. 62/304,897 filed Mar. 7, 2016, which is hereby incorporated by reference.

### FIELD

The present disclosure relates generally heating or heating and drying materials, such as drilling cuttings. More particularly, the present disclosure relates to heating or heating and drying materials through induction heating.

### BACKGROUND

In association with earth drilling, for example drilling a wellbore for oil and gas well drilling, drilling fluid is circulated down the wellbore and across the face of the drill bit, and drilling fluid along with drilling cuttings (for example shale) circulated back up the wellbore to surface.

The drilling cuttings and drilling fluid are separated to some degree, and the drilling fluid re-used.

However, the drilling cuttings with residual drilling fluid must be further treated, processed, or disposed of. The drilling cuttings may contain residual invert drilling fluid, gel or chemical, or bitumen or combination thereof. Government regulation often require such drilling cuttings cannot remain on the location, and must be transported (e.g. by trucking) to a disposal site. It is not uncommon for the drilling cuttings to be so wet and sloppy (i.e. with drilling fluid) that the drilling cuttings must be mixed with a stabilizer, such as wood sawdust, until the mixture is able to satisfy a stability slump test before it can be hauled away from the drilling location to the disposal site. If sawdust is not readily available, trees may be cut down and shredded to prepare sawdust at the location.

At the disposal site, the disposal site operator may record where the drilling cuttings originated, for example a specific rig on a specific geographic location (e.g. GPS location or other identifier such as legal subdivision (LSD) as used in Alberta and British Columbia, Canada) along with the well site information and all of the information of that load whether it is from surface hole with gel/chemical mud or when they switch to invert mud or whether it is from the production or sand zone etc. Depending on the type of material, the disposal site may require the load be dumped in certain places on the disposal site.

The long term effects and responsibility for these materials may be a concern for the oil and gas company and others involved with the drilling operation.

It is, therefore, desirable to provide method and apparatus for drying drilling cuttings. It is also desirable to provide a method and apparatus for heating or drying or heating and drying other feed materials.

### SUMMARY

It is an object of the present disclosure to obviate or mitigate at least one disadvantage of previous techniques for handling drilling cuttings.

In a broad aspect, the present disclosure provides a heater or dryer or both using induction heating and rotary agitation or tumbling.

In a further aspect, the present disclosure provides an induction heater for processing a feed material including a main tube having an internal conveyor, at least one of the main tube or conveyor providing an at least partly ferrous part, one or more electric induction coils for heating the at least partly ferrous part to heat the feed material to provide heated outlet material, and a conveyor drive for driving the conveyor.

In an embodiment disclosed, the conveyor includes a drag chain.

In an embodiment disclosed, the conveyor is an auger, rotatable relative to the main tube by the conveyor drive.

In a further aspect, the present disclosure provides an induction heater for processing a feed material including a rotatable main tube having an internal auger or flighting, at least one of the main tube or internal auger or flighting providing an at least partly ferrous part, one or more electric induction coils for heating the at least partly ferrous part to heat the feed material to provide heated outlet material, and a main tube drive for rotating the main tube.

In an embodiment disclosed, the main tube and the internal auger or flighting are substantially ferrous.

In an embodiment disclosed, the main tube and the internal auger or flighting are steel, stainless steel, or graphite.

In an embodiment disclosed, the induction heater includes a gear crusher for crushing the feed material, the gear crusher including spaced-apart gears, at least one of the spaced-apart gears driven by a gear drive.

In an embodiment disclosed, a gap between the spaced-apart gears is adjustable to provide an adjustable size for the crushed feed material, the particle size between a fine particle dust and a course shale.

In an embodiment disclosed, the induction heater includes a stack adapted to vent or flare at least a portion of outlet vapors from the outlet material.

In an embodiment disclosed, the induction heater includes a cooler adapted to cool outlet vapors from the outlet material.

In an embodiment disclosed, the cooler includes a condenser adapted to condense recovered water from the outlet vapors.

In an embodiment disclosed, the induction heater includes a fire box adapted to cool outlet solids from the outlet material.

In an embodiment disclosed, the induction heater includes a blower adapted to convey the outlet material from the main tube.

In an embodiment disclosed, the induction heater includes a scrubber system adapted to clean outlet vapors from the outlet material.

In an embodiment disclosed, the cooler comprises an air cooler, further including a blower adapted to provide ambient air to the air cooler; a stack or chimney at or near a base of the stack or chimney; or both.

In a further aspect, the present disclosure provides a method of processing a feed material including conveying the feed material through a main tube having an internal conveyor, at least one of the main tube or the conveyor providing a ferrous part, the feed material conveyed through the main tube by the conveyor, heating the feed material by induction heating of the ferrous part, at least a portion of the feed material and at least a portion of the ferrous part in contact, wherein the feed material is heated to provide a heated outlet material.

In an embodiment disclosed, the conveying includes rotating or tumbling the feed material.

In an embodiment disclosed, the conveyor includes an internal auger or flighting, and wherein the conveying includes relative rotation between the conveyor and the main tube.

In an embodiment disclosed, the conveyor comprises an internal auger or flighting, and wherein the internal auger or flighting and the main tube are connected, and wherein the conveying comprises rotating the internal auger or flighting and the main tube together.

In an embodiment disclosed, the internal auger or flighting and the main tube are ferrous.

In an embodiment disclosed, the method includes crushing the feed material prior to heating.

In an embodiment disclosed, the outlet material has a lower moisture content than the feed material.

In an embodiment disclosed, the feed material contains polychlorinated biphenyl (PCB), wherein the feed material is heated up to at least 2150 degrees Fahrenheit for a period of time, to remove the PCBs from the feed material.

In an embodiment disclosed, the method includes recovering outlet vapors from the main tube.

In an embodiment disclosed, the outlet vapors are burned to generate electricity to at least partially supply the induction heating.

In an embodiment disclosed, the feed material includes drilling cuttings.

In an embodiment disclosed, the feed material includes gravel.

In an embodiment disclosed, the feed material is selected from the group of geologic material, hazardous waste, and organic waste.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures. This application includes FIGS. 1-25 on drawing sheets 1/24-24/24.

FIG. 1 is a side view of an induction heater of the present disclosure.

FIG. 2 is a gear crusher of the present disclosure.

FIG. 3 is a side view of an induction heater of the present disclosure.

FIG. 4 is an end view of the induction heater of FIG. 3.

FIGS. 5A-5C illustrate a spiral/helical flighting of the present disclosure.

FIGS. 6A-6C illustrate a spiral/helical auger of the present disclosure.

FIG. 7 is a flow diagram of an induction heater of the present disclosure in a drilling cuttings dryer embodiment in association with a drilling rig.

FIGS. 8-9 are side views of an induction heater of the present disclosure.

FIG. 10 is an end view of the induction heater of FIGS. 8-9, in an embodiment utilizing a plurality of stacks or chimneys and scrubbers.

FIG. 11 is a side view of a induction heater of the present disclosure.

FIG. 12A is a section A-A of FIG. 11.

FIG. 12B is a section B-B of FIG. 11.

FIG. 12C is a section C-C of FIG. 11.

FIG. 12D is a section D-D of FIG. 11.

FIG. 12E is a section E-E of FIG. 11.

FIG. 13A is a side view of a coolant system of the present disclosure.

FIG. 13B is a front view of the coolant system of FIG. 13A.

FIG. 14 is a side view of an induction heater of the present disclosure, depicting about a plus nine (+9) degree slope.

FIG. 15 is a side view of the induction heater of FIG. 14, depicting about a zero (0) degree slope.

FIG. 16 is a side view of the induction heater of FIG. 14, depicting about a minus six (−6) degree slope.

FIG. 17A is a side view of an induction heater of the present disclosure.

FIG. 17B is an end view of the induction heater of FIG. 17A.

FIG. 18 is a side view of the material heater of FIGS. 17A-17B, partly disassembled.

FIG. 19 is a side view of an induction heater of the present disclosure.

FIG. 20 is a side view of an induction heater of the present disclosure.

FIG. 21 is a side view of an induction heater of the present disclosure.

FIG. 22 is an end view of the induction heater of FIG. 21.

FIG. 23 is an end view of the induction heater of FIG. 21.

FIG. 24 is a side view of the induction heater of FIG. 21, illustrating a positive slope.

FIG. 25 is a side view of the induction heater of FIG. 21, partly disassembled.

### DETAILED DESCRIPTION

Generally, the present disclosure provides an apparatus and method for heating materials, in particular heating and drying of a wide variety of materials, including but not limited to drilling cuttings, by induction heating and tumbling.

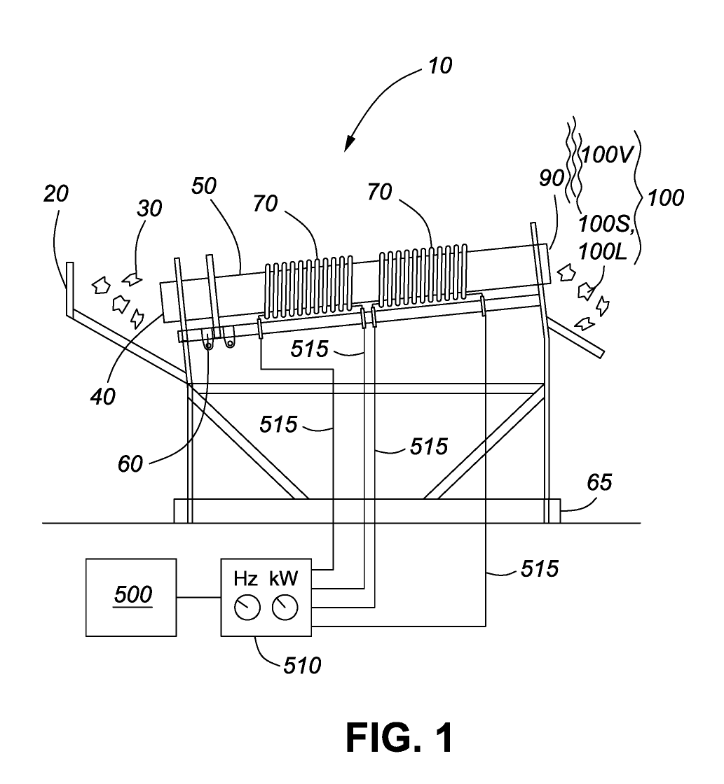

Referring to FIG. 1, an induction heater 10 of the present disclosure may include a feed inlet 20 for providing a feed material 30 to an inlet 40 of a main tube 50. Otherwise, the feed material 30 may be provided directly to the inlet 40, for example by a chute or funnel or other delivery/guide system (not shown). The main tube 50 is rotatable, for example by a main tube drive 60 mounted on frame or skid 65. The main tube drive 60 may be, for example, a hydraulic or electric variable speed drive or without a variable speed. The main tube drive 60 may rotate the main tube 50 through a gearbox to operate a drive chain and sprockets 62 or via a gearbox to rotate the main tube 50 through a pinion and mating gear or otherwise rotate the main tube 50. The main tube 50 rests on two or more rollers 64.

In an embodiment disclosed, the main tube 50 is rotated at a rate such that the contents (e.g. the feed material 30) are tumbled. In an embodiment disclosed, the main tube 50 is rotated at less than about 10 rpm. In an embodiment disclosed, the main tube 50 is rotated at about 4 rpm.

One or more electric induction heater coils 70 are used to heat the feed material 30. The main tube 50 or an internal conveyor 75 or both are at least partially ferrous and thus heatable by the one or more induction heater coils 70. There is a gap between the main tube 50 and the induction heater coils 70, which may include thermal insulation or an air gap or both. The main tube 50 is rotated while the induction heater coils 70 remain stationary.

The induction heater coils 70 are provided with an alternating current voltage source from a power supply 500 via a coil drive 510 and the frequency (Hz) of the alternating current voltage source may be set or adjusted via coil drive 510 to control the depth of penetration of the oscillating magnetic field and the induced eddy currents. The energy (voltage or current or kW) or the temperature or the frequency (Hz) or combinations thereof may be set or adjusted manually or by an automatic control system. The coil drive 510 drives the induction heater coils 70 to control the temperature or heating of the feed material 30 as it passes through the main tube 50 from the inlet 40 to outlet 90. The induction coil drive 510 drives the induction heater coils 70 of any frequency but the lower the frequency the deeper in the heat goes into the main tube 50 and a spiral auger or flighting 80. For example, using a frequency of about 100 Hz or 500 Hz provides deeper penetration than a frequency of 3000 Hz, and a frequency of 1000 Hz would provide a penetration in-between that of 500 Hz and 3000 Hz. The coil drive 510 may preferably receive alternating current (AC) power, for example from a power line, generator, or other source (for example 480V or 600V, 3-phase, 60 Hz) and the AC power is rectified to provide direct current (DC) power, and then a variable inverter is used to provide the AC drive signal to the induction heater coils 70.

The induction heater coils 70 heat the main tube 50 or the spiral auger or flighting 80 or both by magnetic induction heating, and thus the feed material 30 is heated by the main tube 50 or the spiral auger or flighting 80 or both. The main tube 50 is thermally insulated and electrically insulated from the rest of the induction heater 10.

In an embodiment disclosed, electrical conductors 515 between the coil drive 510 and the induction heater coils 70 or within the induction heater coils 70 or both are liquid cooled. In an embodiment disclosed, the electrical conductors 515 between the coil drive 510 and the induction heater coils 70 are twisted together to reduce or cancel out heat and electrical noise and preferably do not exceed about 25-100 feet in length for greater efficiency.

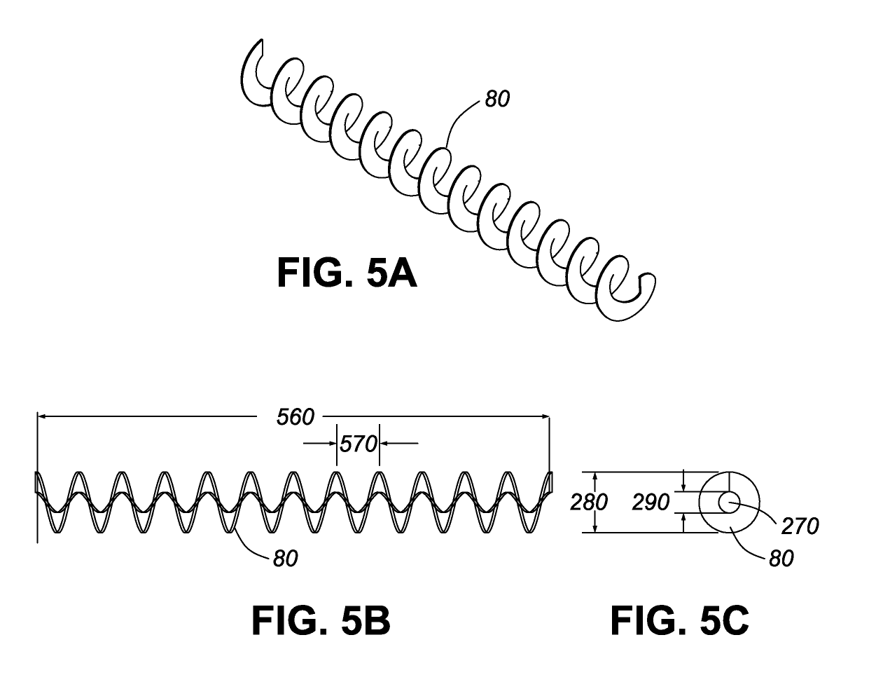

The conveyor 75 is used to convey the feed material 30 through the main tube 50 which is more important when the main tube 50 is sloped upward (described below). The conveyor 75 may be, for example, a drag chain (not shown). However, the conveyor 75 is preferably a spiral auger or flighting 80 (see FIGS. 5A-5C).

Outlet material 100 exits the main tube 50 at the outlet 90. The outlet material 100 may include outlet vapors 100V, outlet liquids 100L, outlet solids 100S or combinations thereof. The makeup of the outlet material 100 is variable depending on the feed material 30 and the extent of heating and temperature applied by the induction heater 10.

In an embodiment disclosed, the outlet material 100 is substantially outlet solids 100S and outlet vapors 100V with minimal liquids 100L.

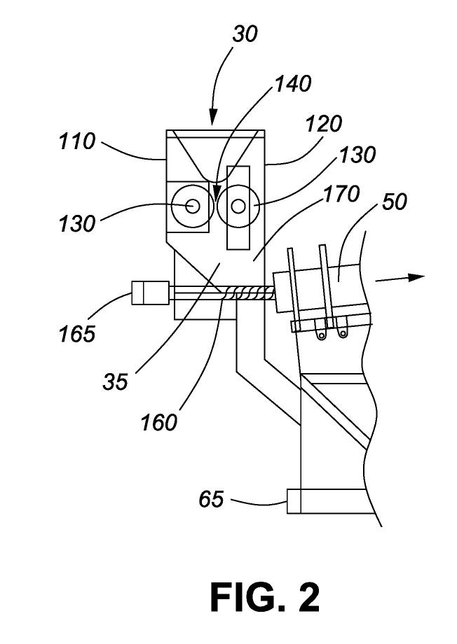

Referring to FIG. 2, a gear crusher 110 receives the feed material 30 and crushes the feed material 30 into crushed feed material 35. The crushed feed material 35 may be a fine powder. The smaller particles require less time to heat or dry or cook. The crushed feed material 35 is easier to handle, convey, heat, or dry or combinations thereof.

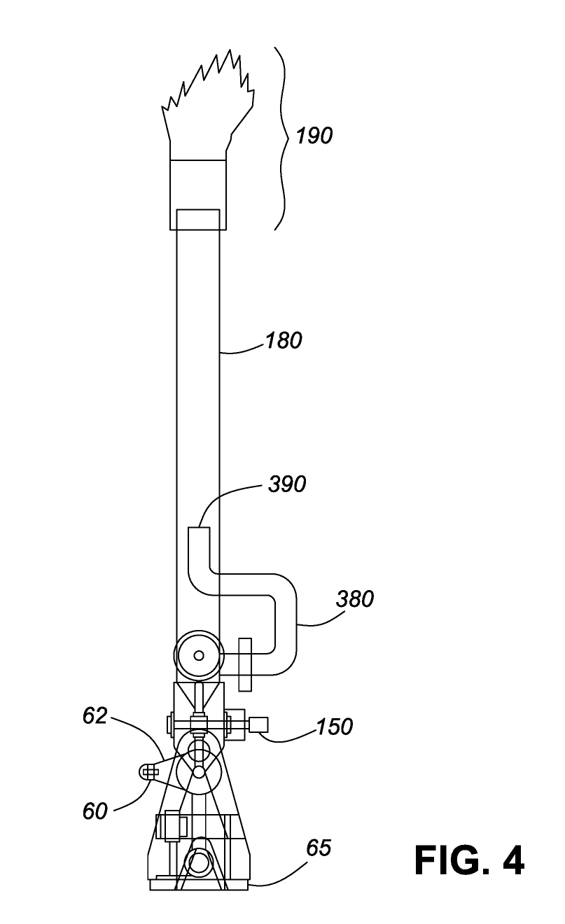

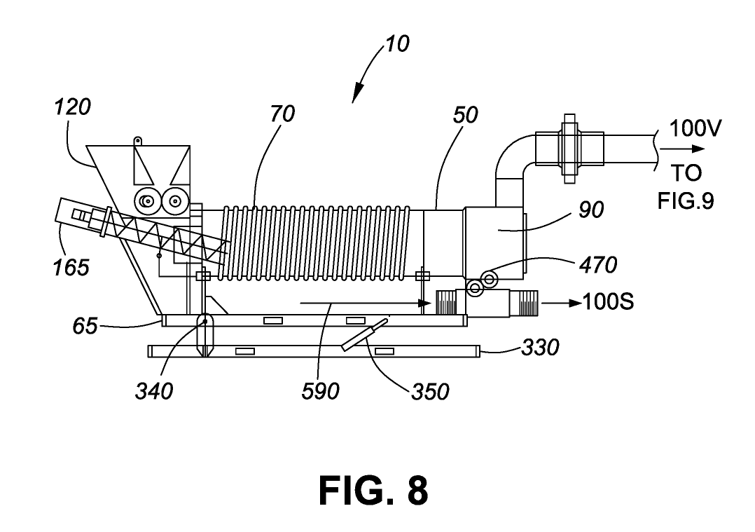

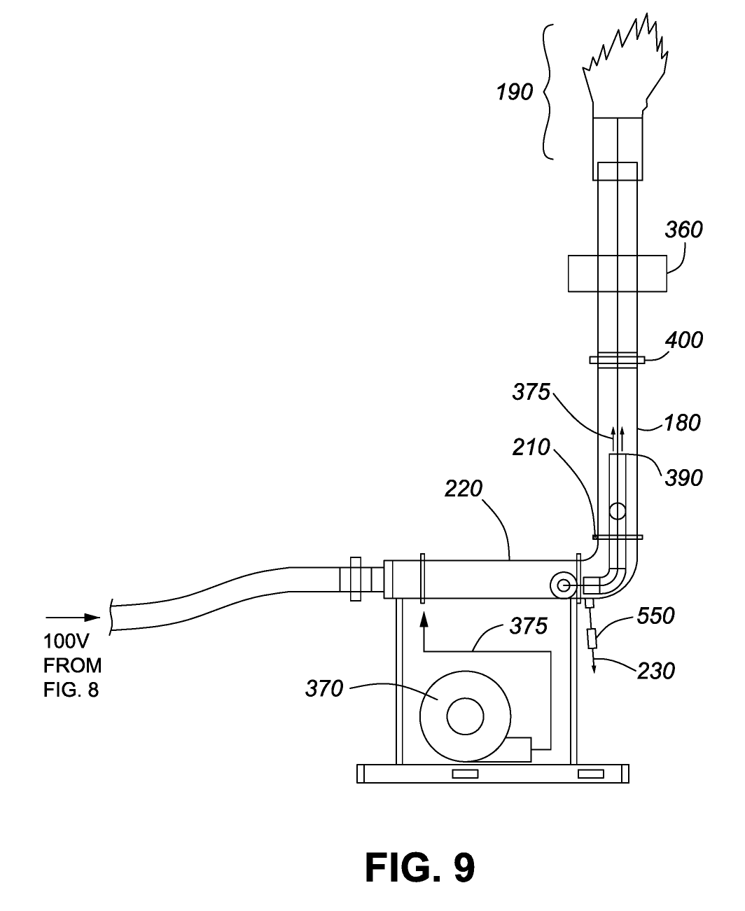

The feed material 30 is received in a hopper 120 of the gear crusher 110. The gear crusher 110 includes gears 130 spaced apart having an adjustable gap 140. In an embodiment disclosed, the gears 130 are involute gears. In an embodiment disclosed, the gears 130 are herring bone or splines or simple V-shaped or square or shaped to crush the feed material 30 (e.g. shale drilling cuttings) to finer particles. One or more of the gears 130 are driven by a drive 150 (see FIG. 4), for example a hydraulic or electric drive, with or without a variable speed drive. An auger feed 160 at or proximate a bottom 170 of the hopper 120 feeds the crushed feed material 35 to the inlet 40 of the main tube 50. The auger feed 160 is driven by a drive 165, for example a hydraulic or electric drive with or without a variable speed drive. In some conditions, merely passing the feed material 30 (e.g. oil, water, fluid or combinations thereof covered or saturated drilling cuttings) through the gear crusher 110, provides some degree of drying of the feed material 30. The adjustable gap 140 can be adjusted on the go, real-time or substantially real-time either electrically or hydraulically or manually to adjust the size of the crushed feed material 35 between a fine powder to course particles like shale. A similar gear crusher 470 (see FIG. 8) may be provided after the outlet 90 of the main tube 50. Rather than a gear crusher 110, a grinder or shredder (not shown) may be provided to reduce the size of the feed material 30, depending on the feed material 30. In an embodiment disclosed, the shredder is a SSI or JWC garbage shredder, for example when the feed material 30 is garbage (see below).

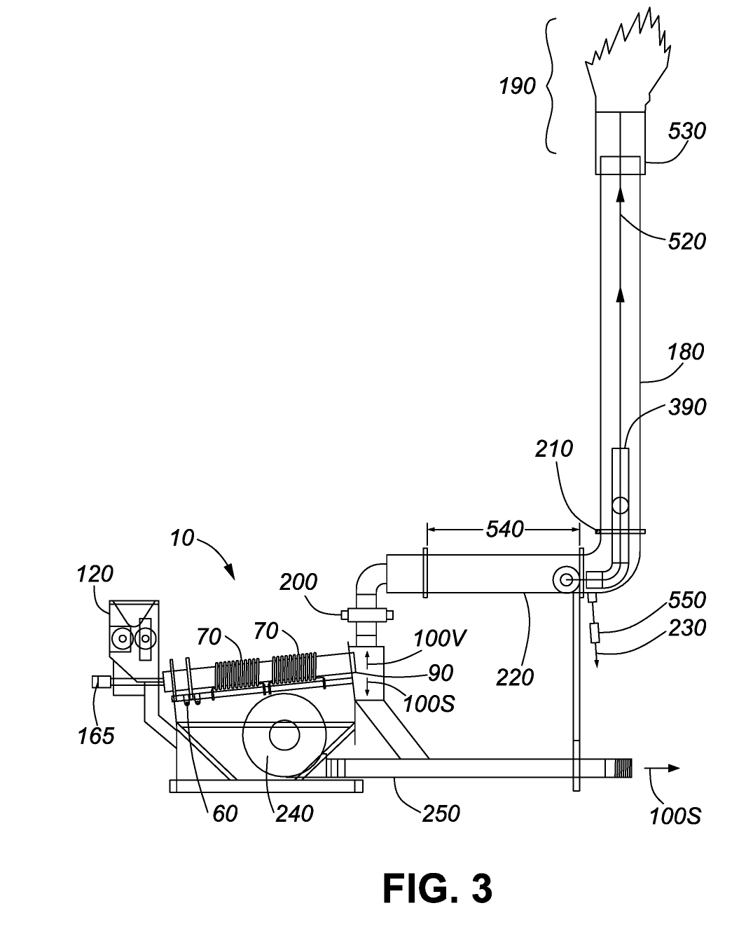

Referring to FIGS. 3 and 4, an induction heater 10 of the present disclosure includes the gear crusher 110 of FIG. 2. In addition, outlet vapor 100V (e.g. steam and other gaseous components) may be vented via a stack or chimney 180. As the hot vapors rise up the stack or chimney 180 a venturi effect 520 draws vapors from the main tube 50 and up the stack or chimney 180.

In some conditions (e.g., temperature and composition of the feed material 30), combustible components may ignite and burn in the main tube 50 (thus the rising slope of the main tube 50). The stack or chimney 180 may include a flare 190, ignited by one or more electric ignitors 530, if the feed material 30 includes flammable components (e.g. hydrocarbons such as diesel fuel based invert drilling fluid or bitumen) such that any flammable vapors, if any, in outlet vapor 100V may be flared (burned) off. The stack or chimney 180 may be releasably connected with the induction heater 10 and one or more portions of the stack or chimney 180 may be hinged or articulated to facilitate transition between a working mode (FIGS. 3 and 4) and a transportation mode, the stack or chimney 180 disconnected and folded down (not shown) and the air cooler or condenser unit 220 disconnected. In an embodiment disclosed, a connection 200, for example a hammer union or other releasable connection, allows connection/disconnection of the stack or chimney 180 and the induction heater 10. In an embodiment disclosed, a hinge 210 allows folding and unfolding of the stack or chimney 180.

The temperature of the outlet material 100 and outlet vapor 100V at the outlet 90 of the main tube 50 may be in the 600 degrees Fahrenheit to 2150 degrees Fahrenheit range. An operating temperature of about 600 degrees Fahrenheit may be used in normal operation, and the higher 2150 degrees Fahrenheit used when the feed material 30 includes polychlorinated biphenol (PCB) components. In an embodiment disclosed, a temperature of about 600 degrees Fahrenheit is suitable for drying sand. In an embodiment disclosed, the air cooler or condenser unit 220 may be used to cool the outlet vapors 100V. The air cooler or condenser 220 reduces the temperature of the outlet vapors 100V to reduce the risk that hot particles released from the stack or chimney 180 could be an ignition source, for example if in the forest a forest fire in the surrounding area. The length 540 of the air cooler or condenser 220 is sized to provide sufficient cooling or condensing of the outlet vapors 100V.

In an embodiment disclosed, the induction heater 10 may be equipped with a fire suppression system to extinguish or prevent the spread of fire. The fire suppression system may utilize one or more of dry chemicals, wet agents, gas, or water. In an embodiment disclosed, the fire suppression system uses an inert gas or halocarbon compounds. In an embodiment disclosed, the fire suppression system uses halon.

If the outlet material 100V includes water vapor, at least some water vapor (steam) may be sufficiently cooled to be condensed by the air cooler or condenser unit 220 to form recovered water 230 at drain 550.

Solid outlet material 100S, (e.g. dried drilling cuttings) may be conveyed from the induction heater 10 by a blower 240. In an embodiment disclosed the blower 240 delivers air 590 through a conduit 250. In an embodiment disclosed, the outlet 90 of the main tube 50 and the conduit 250 are fluidly connected, the flowing air 590 inducing a draft in the main tube 50 though the venturi effect. A further gear crusher (470 FIG. 8) may be provided between the outlet 90 of the main tube 50 and the conduit 250. In an embodiment disclosed, the blower 240 provides a flow of between about 500 CFM and 10,000 CFM at about 0.3 to 1psi, for example about 1875 CFM at about 0.5 psi. However, these numbers are just examples, and the flow rate and pressure of air 590 may be higher or lower as needed. The blower 240 or another blower (not shown) may also provide cooling air to the outlet material 100 (e.g. outlet solids 100S) or to a storage tank (not shown) where outlet material 100 (e.g. outlet solids 100S) are stored.

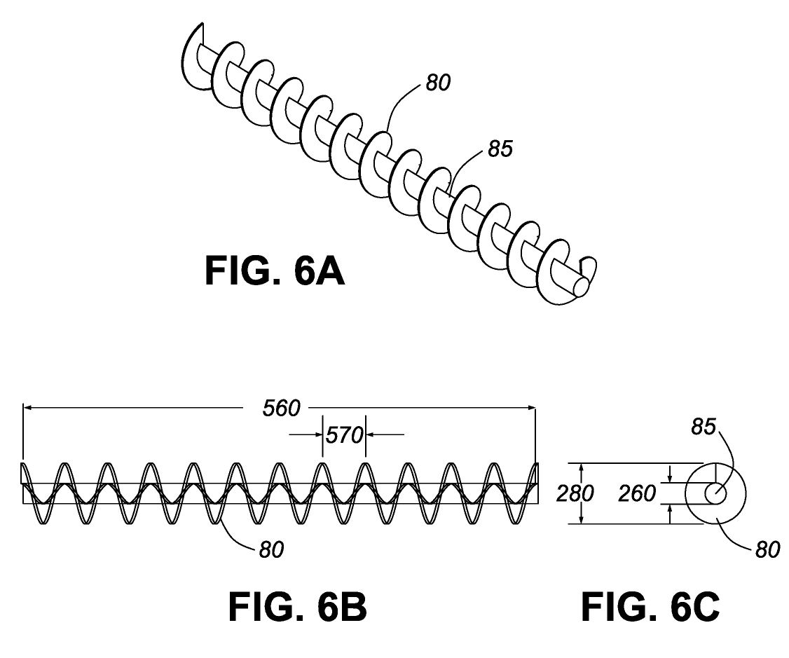

Referring to FIGS. 5A-5C and 6A-6C, the main tube 50 includes the internal spiral auger or flighting 80. In an embodiment disclosed, a central portion is open (FIGS. 5A-5C), having an open area 270 having an open area diameter 290, sometimes referred to as a flexible screw conveyor. In an embodiment disclosed, the spiral auger or flighting 80 has an outer diameter 280 which matches the inner diameter of the main tube 50. In an embodiment disclose, a central portion includes a central pipe 85 (FIGS. 6A-6C), having a diameter 260, sometimes referred to as a solid core screw conveyor. While the spiral auger or flighting 80 is shown as continuous, both in terms of extending from the beginning to the end and in terms of extending about the circumference of the main tube 50, one may instead utilize several angled tumbler plates extending along the length and around the circumference approximating the general shape or configuration of the spiral auger or flighting 80 with or without gaps, forming an angled conveyor.

In an embodiment disclosed the main tube 50 is a 6⅝″ OD pipe with an ID of 5.761″ Inches, and a length of about 40 inches long is heated with induction heater coils 70. In an embodiment disclosed, the main tube 50 has a 30″ OD and 29″ ID and a length of about 72 inches long is heated with induction heater coils 70. In an embodiment disclosed, the main tube 50 is about 9 feet long and the spiral auger or flighting 80 starts at the inlet 40 and runs through the entire main tube 50 to the outlet 90, i.e. length 560 is also about 9 feet.

The spiral auger or flighting 80 has a spiral pitch 570. However, these configurations are just examples. The feed material 30 may be conveyed through the main tube 50 by rotation of the spiral auger or flighting 80, and the spiral auger or flighting 80 may be attached to and rotate with the main tube 50 as the main tube 50 is rotated, or the spiral auger or flighting 80 may be rotated and the main tube 50 stationary. In an embodiment disclosed, the main tube 50 or the internal auger or flighting 80 or both may be made of steel, stainless steel, or graphite (e.g. graphite crucible).

In an embodiment disclosed, the main tube 50 may be welded pipe or seamless pipe. In an embodiment disclosed, the main tube 50 is seamless pipe. This is more important at higher energy rates (kW) levels. Welded pipe may be used, but if the induced eddy currents are high, the eddy currents will attack the internal welds and eat the welds out of the welded pipe. As noted previously, the main tube 50 is electrically isolated/insulated from the other components so that the induced/eddy currents do not damage the other components.

The auger or flighting 80 may be connected to the main tube 50 at non-coil areas of the main tube 50 in order to avoid eddy current damaging fasteners (such as welds or bolts). In an embodiment disclosed, the auger or flighting 80 is seamless without welds and is held in place by one or more fasteners (e.g. bolts), the one or more fasteners at a non-coil areas of the main tube 50, the non-coil areas of the main tube 50 being the portions of the main tube 50 not covered by the induction heater coils 70. The inlet 40 and the outlet 90 for example are shown as non-coil areas. The spiral auger or flighting 80 may be changed out very quickly if need be, for example to change the spiral pitch 570, clear an obstruction, replace the spiral auger or flighting 80, or perform other maintenance.

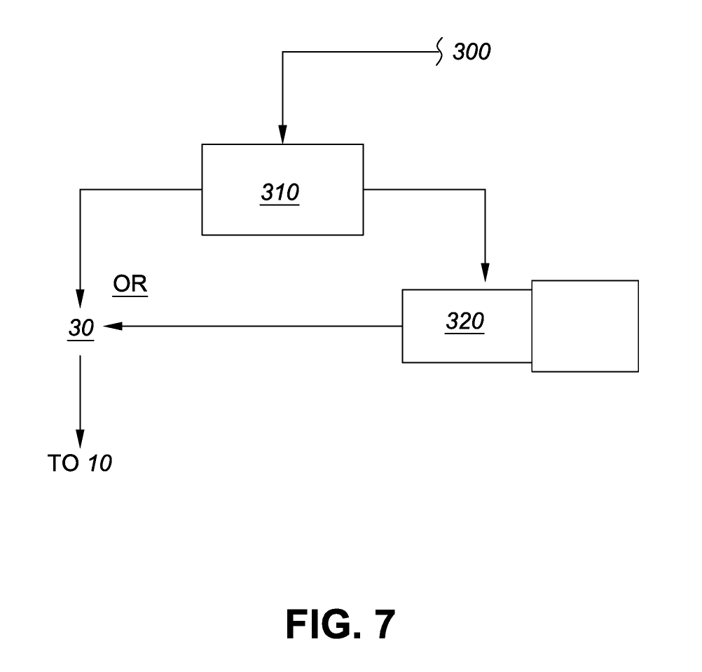

Referring to FIG. 7, in association with an earth drilling operation, known to a person of ordinary skill in the art, drilling cuttings 300 generated by the drilling operation are typically at least partially processed to recover at least a portion of the drilling fluid for re-use. This typically includes passing the drilling cuttings 300 though a vibratory separator commonly referred to as a shale shaker 310 (which may be a vacuum type shale shaker or screens) or a shale shaker 310 and a centrifuge 320 or other system for separating the drilling cuttings and the drilling fluid typically associated with or part of an earth drilling rig. In an embodiment disclosed, the drilling cuttings off the shale shaker 310 or the centrifuge 320 or both form the feed material 30 for the induction heater 10 of the present disclosure. In this embodiment, the induction heater 10 performs as a drilling cuttings dryer to heat to a sufficient degree and thereby dry the drilling cuttings 300 (as feed material 30). In an embodiment disclosed, the drilling cuttings 300 are from drilling operations using invert drilling fluids (hydrocarbon based, for example diesel fuel based) or gel shale or chemical shale or bitumen shale.

Recovered water 230 (see FIG. 9), if any, may be suitable for recycling or reuse, for example to provide water for utility water or process water or re-use in making or diluting drilling fluid to use in the drilling operation.

The outlet material 100, and in particular the outlet solids 100S may be tested. If within government regulations, the outlet solids 100S (e.g. dried drilling cuttings) may be spread back on the lease road or back on location. Thus avoiding the need for offsite disposal and avoiding the need for stabilizer (e.g. sawdust), personnel to mix the sawdust and the drilling cuttings, the trucking costs, and the long term impact of and responsibility for the drilling cuttings at the disposal site.

In an embodiment disclosed, the induction heater 10 of the present disclosure may be used to remediate a lease or drilling location or drilling cuttings disposal site. Rather than processing drilling cuttings 300 from the shale shaker 310 or centrifuge 320 of a drilling operation in real-time or substantially real-time as they are produced, the previously untreated drilling cuttings (e.g. mixed with sawdust and deposited at a disposal site) are conveyed to the inlet 40 of the induction heater 10 as feed material 30. This provides, for example, for the remediation of drilling cuttings disposal sites or other concentrations or piles or dumps of shale drilling cuttings.

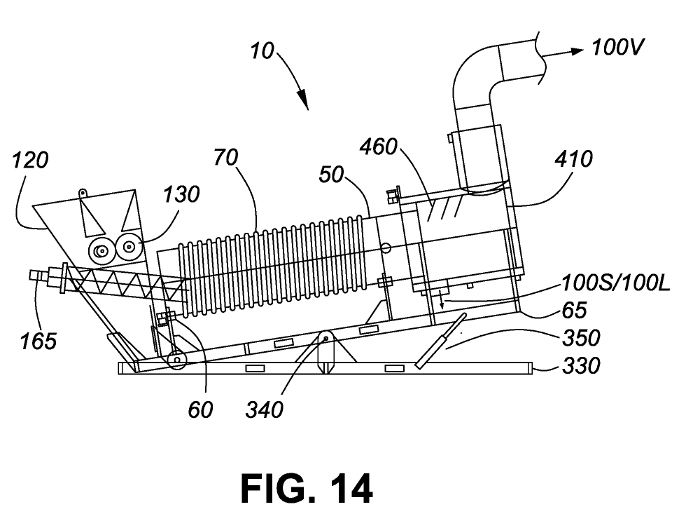

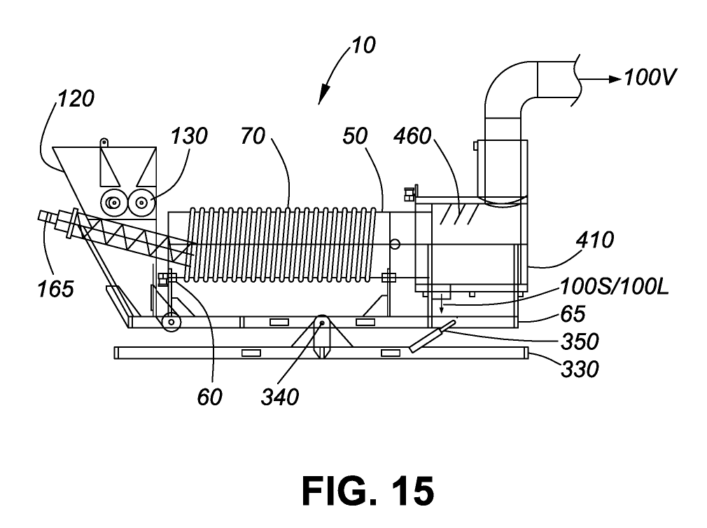

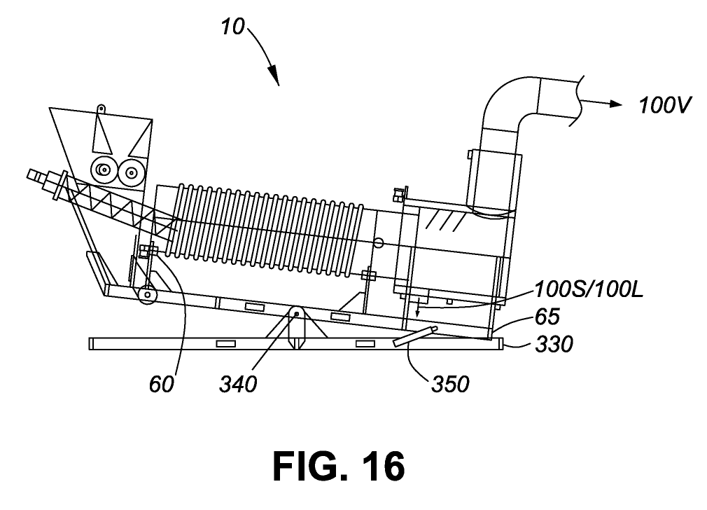

Referring to FIGS. 8-9, the slope of the main tube 50 may be selectively set or adjusted. In an embodiment disclosed the frame or skid 65 of the induction heater 10 is pivotable relative to a bed 330 about a pivot 340. In an embodiment disclosed, one or more actuators 350 may be used to selectively set or adjust the slope of the main tube 50. The actuator 350 may be, for example, a hydraulic cylinder, pneumatic cylinder, electric actuator or other actuator. In an embodiment disclosed, the main tube 50 may be preset at a certain fixed angle. In an embodiment disclosed, the slope of the main tube 50 may be selectively set or adjusted between about plus 45 degrees and about minus 30 degrees (see FIG. 14 at about plus 9 degrees, FIG. 15 at about 0 degrees (horizontal), FIG. 16 at about minus 4 degrees). In an embodiment disclosed the main tube 50 is sloped, rising from the inlet 40 to the outlet 90. In an embodiment disclosed, the main tube 50 has a slope of about plus 6 degrees.

In an embodiment disclosed, the feed material 30 is heated such that it becomes at least partially molten. In an embodiment disclosed, the feed material 30 is drilling cuttings 300, which become molten glass. In such operation, the main tube 50 must be selectively set or adjusted to at least a slight downward slope (at least 1 degree downward, e.g. minus 1 degree) as a liquid does not flow uphill. However, the slight downward slope still allows any vapors to escape to the outlet 90 of the main tube 50 due to the venturi effect of the blower 370 and natural convection up the stack or chimney 180. A greater downward slope on the main tube 50 may be used with enough induced or forced air flow to ensure that the fumes or gases (i.e. outlet vapors 100V) exit the outlet 90 of the main tube 50.

Outlet vapors 100V from the outlet 90 of the induction heater 10 are passed through an air cooler or condenser unit 220, through a stack or chimney 180, and a scrubber 360, and a flare 190 is used to burn off any remaining combustibles. The scrubber 360 is configured for the operating conditions, for example but not limited to temperature, outlet vapors 100V, and flowrate, and may include for example a dry type scrubbers, such as a baghouse to filter out particulate or fine particulate in the outlet vapors 100V. The air cooler or condenser unit 220 may be provided with a source of ambient air by a blower 370. The air 375 is routed through the air cooler or condenser unit 220, thereby cooling the outlet vapors 100V, and the air 375 is then routed into the stack or chimney 180 at piping 380 and exits at outlet 390 within the stack or chimney 180. The air 375 induces or enhances the flow of the outlet vapors 100V up the stack or chimney 180. In addition, by cooling the vapors 100V, the temperature is reduced which reduces the risk of starting a forest fire due to hot cinders and reduces the cost of the instrumentation for monitoring the vapors from the stack or chimney 180 (commonly available equipment may be used instead of very expensive high temperature testing equipment). The induction heater 10 and air cooler or condenser unit 220 may be housed in a building (not shown) and the stack or chimney 180 would extend through the roof of the building. In an embodiment disclosed, the outlet vapors 100V from the stack or chimney 180 would be less than about 80 degrees Fahrenheit. Depending on the composition of the outlet vapors 100V at least a portion of the outlet vapors 100V may condense. Condensed liquid may be collected at the drain 550.

The scrubber 360 may be a wet or dry scrubber to clean the particulate and gasses and smoke out of the outlet vapors 100V before exiting the stack or chimney 180.

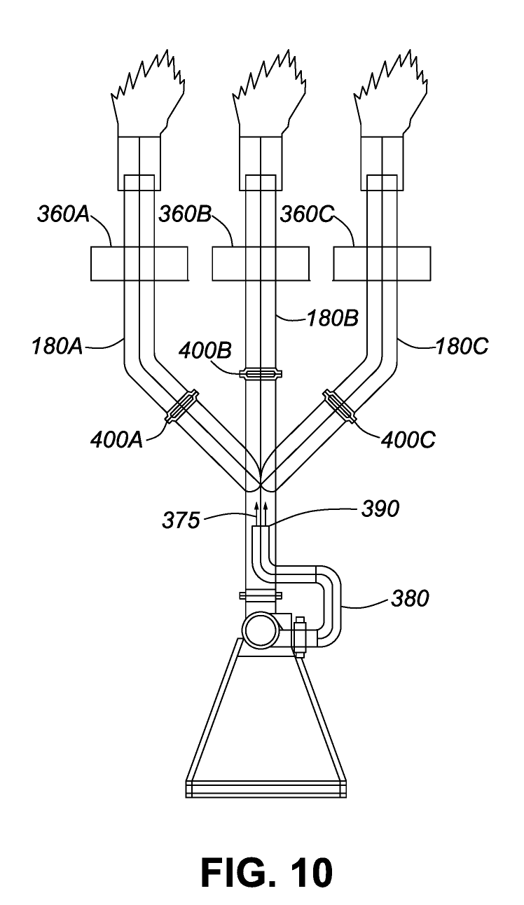

Referring to FIG. 10, in an embodiment disclosed, a plurality of different scrubbers 360A, 360B, 360C may be set on respective stacks or chimneys 180A, 180B, 180C, the flow selectively controlled by respective valves 400A, 400B, 400C. This may be used to provide redundancy to allow continuous operation or the scrubbers 360A, 360B, 360C may be each tailored to a particular type of waste (e.g. camp garbage, invert shale, gel chemical, bitumen shale, gasoline spills, oil spills, bitumen spills, soil, or other type of clean up depending on the feed material 30. In an embodiment disclosed, for example, the scrubber 360A may be for camp garbage vapor scrubbing, the scrubber 360B may be for invent shale vapor scrubbing, and the scrubber 360C may be for gel chemical vapor scrubbing, and the valves 400A, 400B, 400C set accordingly when the particular material is being processed by the induction heater 10, e.g. valves 400A, 400C closed and valve 400B open to direct the outlet vapors 100V to the scrubber 360B when processing invert shale feed material 30. While three scrubbers 360 are shown, that is merely for illustration and more or less scrubbers may be used. Some feed materials 30 do not require any scrubber.

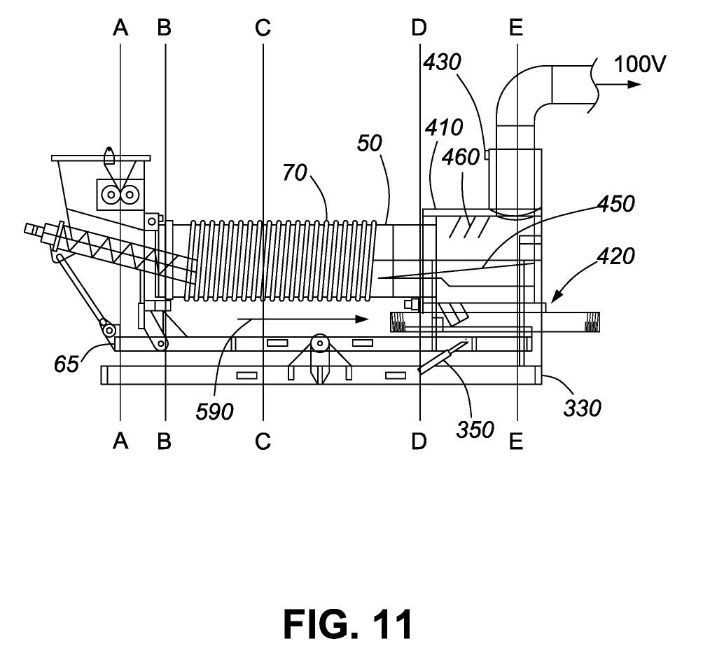

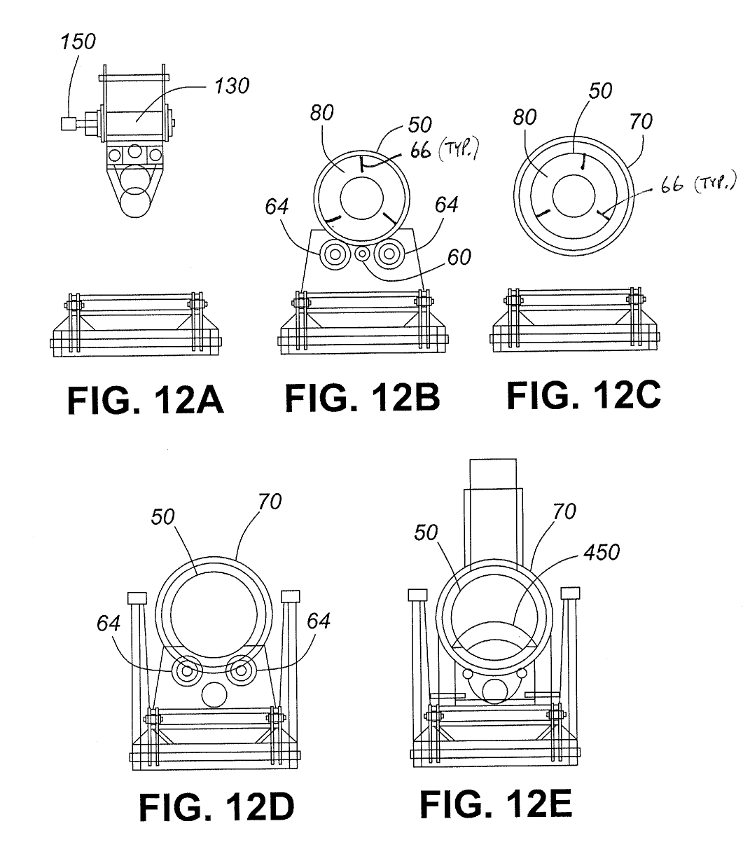

Referring to FIG. 11, 12A-12E, a liquid cooled fire box 410 may be provided at the outlet 90 of the main tube 50. A deflector 450 extends across the inside of fire box 410 and may extend at least partially into the main tube 50. One or more baffles 460 extend downward from the ceiling of the fire box 410. The deflector 450 and the baffles 460 may assist to deflect fine particles in the outlet vapor 100V from escaping up the stack or chimney 180. One or more tumbler slats 66 (three shown, approximately 120 degrees apart) may extend along the length of the main tube 50 to tumble the feed material 30 as it is conveyed through the main tube 50. The tumber slats 66 extend from the wall of the main tube 50 into the main tube 50 and act as a paddle to tumble the feed material. A notch may be cut into the auger or flighting 80 to accommodate the tumber slats 66 or the tumbler slats 66 may be provided between the flights or the auger or flighting 80.

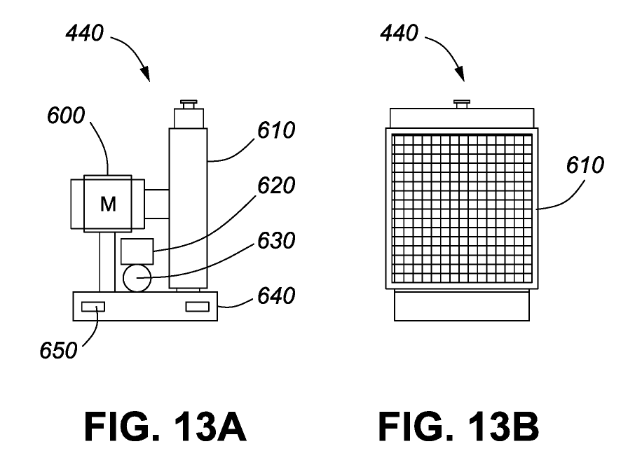

Cooling liquid, for example a glycol/water mix, is provided by a coolant system 440 (see FIG. 13A, 13B) and to inlet 420, circulated through the walls of the fire box 410 absorbing heat, out outlet 430 and back to the heat exchanger and cooling pump 440 for heat rejection, and so on, in a loop.

Referring to FIG. 13A, 13B, the coolant system 440 includes a heat exchanger 610, e.g. a radiator and a drive 600, e.g. for a fan. A pump 630 driven by a drive 620 circulates coolant through the coolant system 440 and the fire box 410. The coolant system 440 is mounted on a support skid 640 and has openings 650 to facilitate handling by forklift.

In an embodiment disclosed, rather than use the coolant system 440, heat may be recovered from the fire box 410 for example to heat a building or a drilling rig or other purposes. In an embodiment disclosed, heat may be recovered from the fire box 410 or otherwise from the outlet material 100 to drive a generator, for example by creating pressurized steam to power a turbine to drive a generator to produce electricity to at least partially supply the power supply 500 or other electrical needs of the induction heater 10. In addition, combustible vapors may be recovered from the outlet vapors 100V and used to drive a generator, for example by combustion to power an internal combustion engine to drive a generator to produce electricity to at least partially supply the power supply 500 or other electrical needs of the induction heater 10. Heat recovered from the fire box 410 or otherwise from the outlet material 100 to preheat the feed material 30.

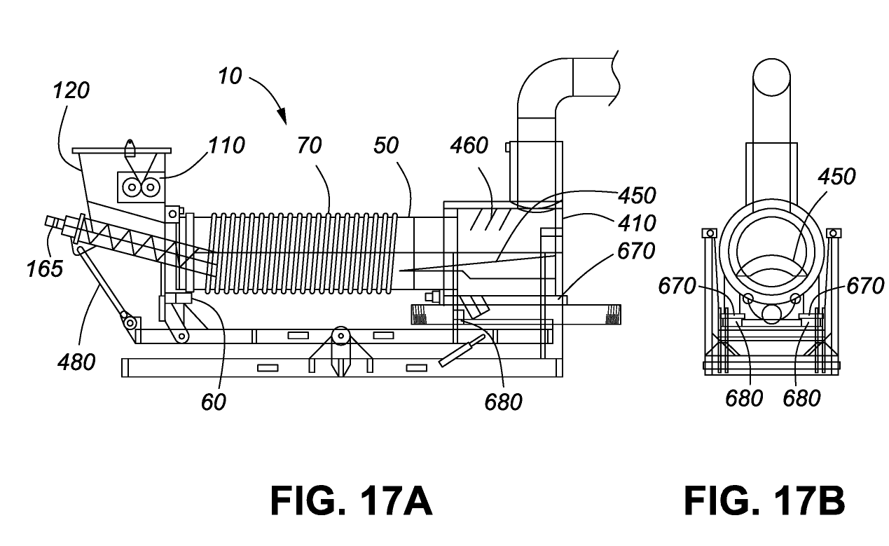

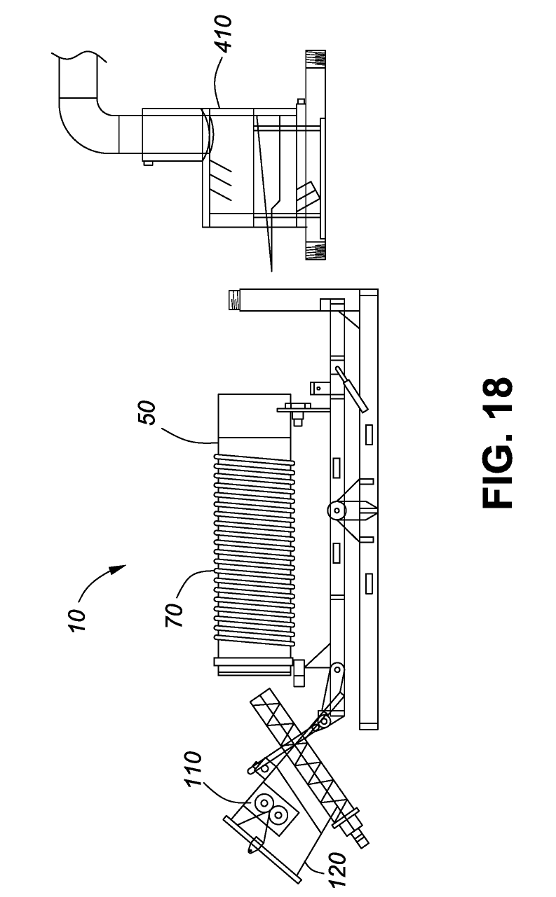

Referring to FIGS. 17A, 17B, 18, in an embodiment disclosed, the induction heater 10 may be readily disassembled. Removal of pins 680 allows removal of the fire box 410. Forklift pockets 670 facilitate handling of the fire box 410 by a forklift. Release of a brace 480 allows the hopper 120 and gear crusher 110 to swing away from the main tube 50 to provide access to the main tube 50 or induction heater coil 70 or both to facilitate inspection, maintenance or repair.

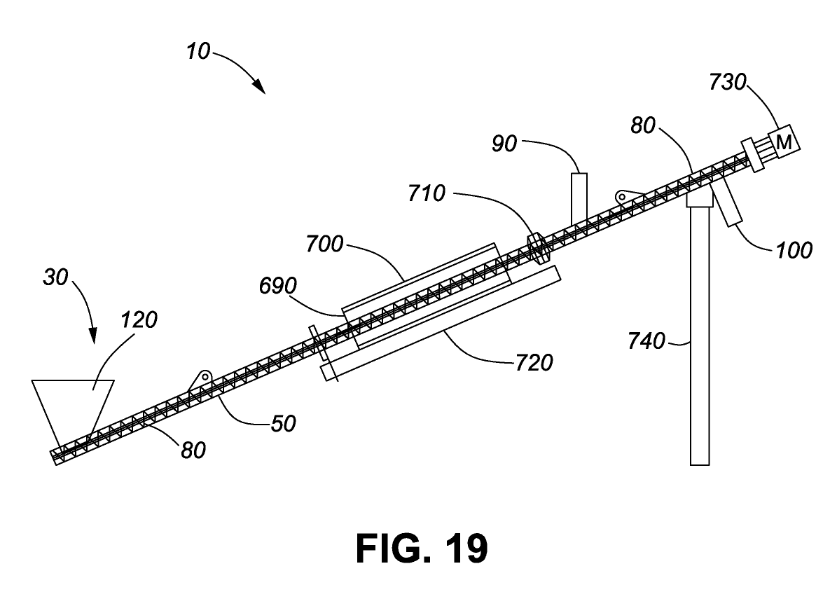

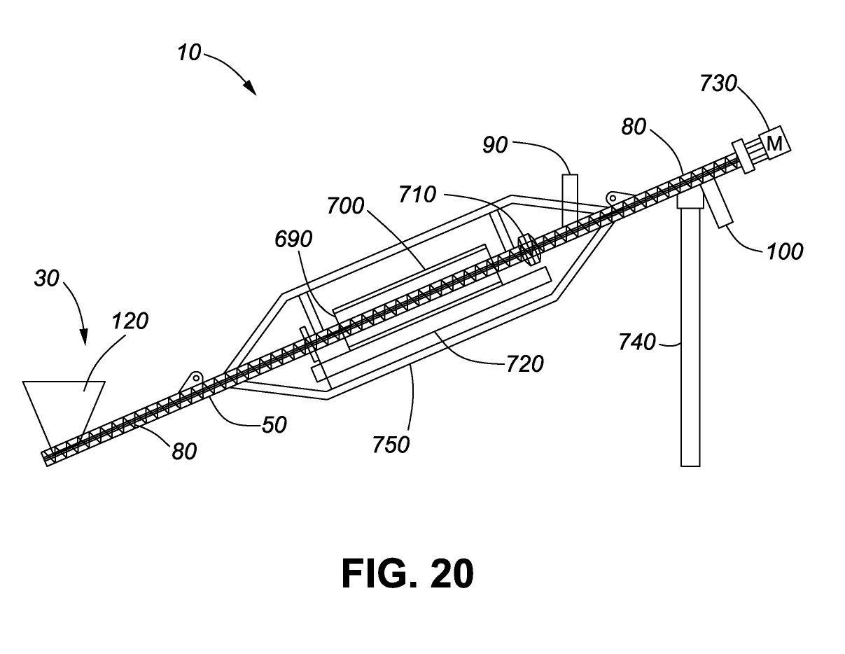

Referring to FIGS. 19-20, in an embodiment disclosed, the main tube 50 does not rotate. An induction coil 700, on the outside of the main tube 50 with an insulation gap 690 between the induction coil 700 and the main tube 50, also does not rotate. An internal rotatable spiral auger or flighting 80 is rotated by drive 730 to convey the feed material 30 through the main tube 50. The induction coil 700 is mounted on a non-conducting support 720. This configuration may include the gear crusher 110, stack or chimney 180, gear crusher 470, air cooler or condenser 220, blower 240, blower 370, and other features described herein or combinations thereof (but not shown in these figures). A flange 710 may be provided to allow the main tube 50 to be disassembled for transport. The main tube 50 is supported by support 740. A support frame 750 may be provided to provide additional structural strength to the main tube 50.

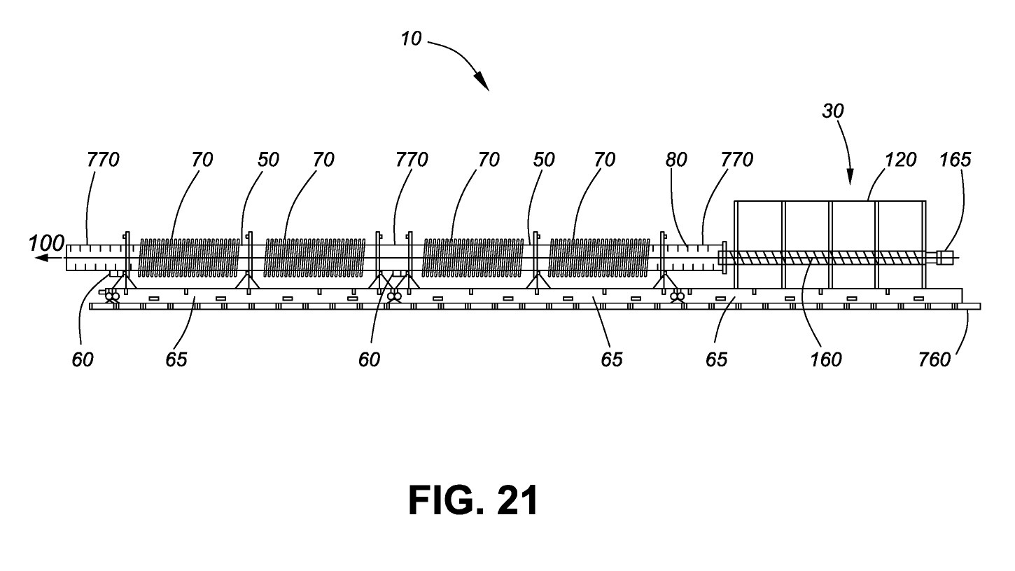

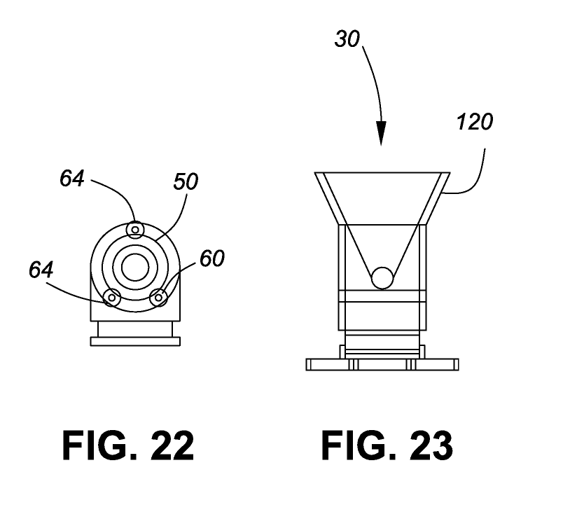

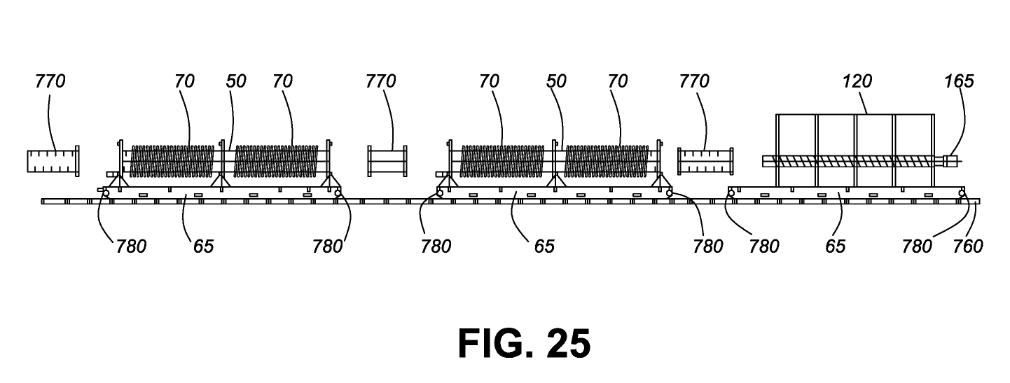

Referring to FIGS. 21-25, in an embodiment disclosed the induction heater 10 may be modular to facilitate a wider range of operating parameters (e.g. material processed, temperature rise, throughput, etc.) and to provide improved mobility. A hopper 120 may be connected with multiple main tubes 50 having internal spiral auger or flighting 80 with induction heater coils 70 on frames or skids 65 may be joined by spool pieces 770, that bolt into place. The internal spiral auger or flighting 80 may be provided by several angled tumbler plates or vanes extending along the length and around the inner perimeter approximating the general shape or configuration of the spiral auger or flighting 80 with or without gaps. The angled tumbler plates may be continuous or semi-continuous. This configuration may be used, for example, for heating gravel or drying sand as the feed material 30, where heavy durable components are required. The main tube 50 and the induction heater coils 70 may be covered with insulation, such an insulated tarp or blanket to reduce ambient heat loss.

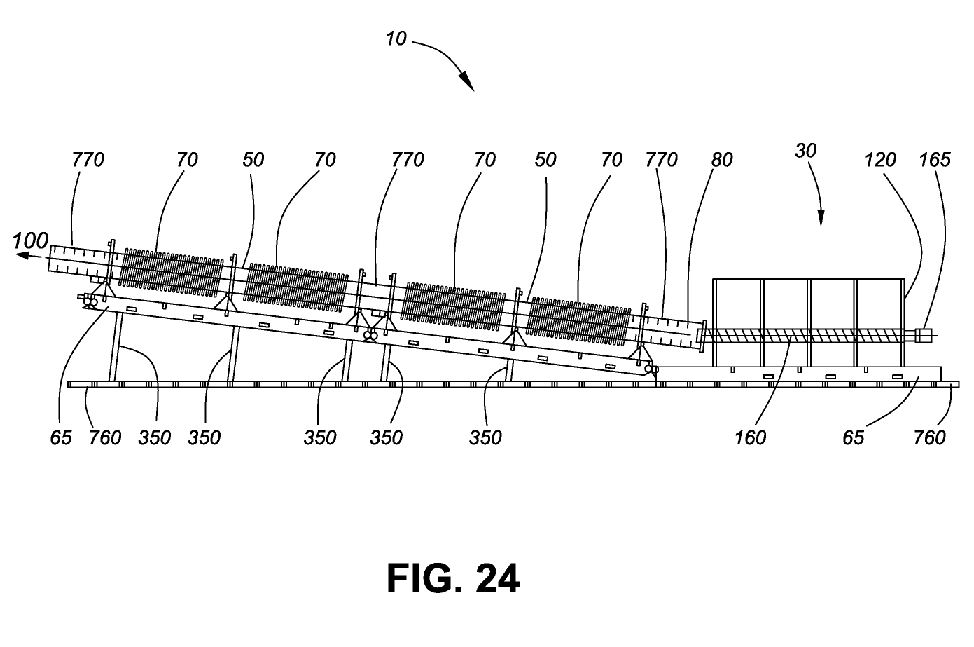

Actuators 350 are used to set an incline (FIG. 24) or decline (not shown) or level configuration (FIG. 21). The frames or skids 65 may have wheels or rollers 780 that mate with rails or mats 760 to facilitate assembly and disassembly.

In an embodiment disclosed, the induction heater 10 may be used to reduce the moisture content or increase the temperature of a wide variety of solid, semi-solid, granular, powder, sludge, or slurry materials. The moisture removed may be from within the material, e.g. interstitial, pore space, or otherwise, or may be from the exterior surfaces of the material or combinations thereof.

As mentioned previously, the induction heater 10 may be used to dry drilling cuttings. In an embodiment disclosed, the feed material 30 is drilling cuttings from drilling operations using invert drilling fluids (hydrocarbon based, for example diesel fuel based) or gel shale or chemical shale or bitumen shale. In addition to processing drilling cuttings 300, the feed material 30 may include snow or ice contaminated with hydrocarbons, water, salt water, or hydrocarbons (for example invert drilling fluid which may include about 10-100 percent diesel fuel).

In an embodiment disclosed, the induction heater 10 may be used to reduce the moisture content or increase the temperature of geologic materials or both. The geologic materials may include dirt, soil, rocks, shale, gravel, sand, aggregate, sludge, sediment, sludge or other geologic materials. The geologic materials may be used, for example, in dam construction, building construction, or other earthwork construction. In such an embodiment, the induction heater 10 would not likely require a scrubber 360. The geologic materials may be excavated, processed through the induction heater 10 and redeposited in order to remove contaminants. In an embodiment disclosed, the induction heater 10 may be used to reduce the moisture content or increase the temperature of soil or sediment or sludge obtained from the bottom of a body of water such as a river or lake for example by dredging, suction/vacuum/hydro excavation, or other excavation in order to remove contaminants.

In certain construction operations, such as pouring high-strength or high-performance concrete in cold climates, processing the aggregate through the induction heater 10 (for example as in FIGS. 21-25) provides aggregate free from excess contamination such as snow, ice, hydrocarbons, and the aggregate may be provided at a sufficiently high temperature to enable or facilitate the concrete curing chemical reaction to occur, even in freezing conditions. In an embodiment disclosed, the material (for example gravel) is heated to an outlet temperature, and then used before the temperature drops too low. If it does, the material may simply be re-heated and used before the temperature drops too low.

In certain construction operations, excavated geologic materials may be processed through the induction heater 10 as the feed material 30 and then the outlet material 100 re-deposited. This excavate-dry-backfill process may be very useful in, for example, excavation or boring of earth in underground tunnel construction.

In an embodiment disclosed, the induction heater 10 may be used to reduce the moisture content of organic waste material, such as manure, animal dung, agricultural wastewater, blackwater, greywater, human feces, urine, or sewage.

In an embodiment disclosed, the induction heater 10 may be used to reduce the moisture content of mining waste, such as tailings. The tailings may be, for example gold mining tailings or oil sands tailings. The oil sands tailings may be mature fine tailings (MFT). The tailings may be processed as they are produced, or the induction heater 10 may be used to process accumulated tailings, for example tailings piles, dumps or settled tailings from tailings ponds.

In an embodiment disclosed, the induction heater 10 of the present disclosure may be used to reduce the moisture content of waste, such as hazardous waste, medical waste, or biomedical waste. In this embodiment, the outlet material 100 (which may include one or more of outlet vapors 100V, outlet solids 100S, and outlet liquids 100L), may still constitute hazardous waste, and if that is the case, must be handled and contained accordingly.

In an embodiment disclosed, the induction heater 10 of the present disclosure may be used to reduce the moisture content or volume or both of mixed waste, such as domestic or industrial garbage.

In an embodiment disclosed, the material dryer 10 of the present disclosure may be used to process waste, selected from one or more or combinations of:

domestic trash;

domestic mud;

industrial mud;

fly ash;

gypsum;

hazardous waste;

domestic solid waste;

industrial waste;

sludges from domestic water treatment;

sludges from industrial water treatment;

mud from biochemical water treatment system;

bottom ash;

dredging spoil containing dangerous substances;

sludges containing dangerous substances from biological treatment of industrial waste water;

sludges containing dangerous substances from other treatment of industrial waste water;

sludges from oil/water separators;

mineral-based chlorinated engine, gear and lubricating oils;

waste fluids;

oil from oil/water separators;

fuel oil, diesel;

oily water from oil/water separators;

wastes containing oil;

waste paint and varnish containing organic solvents or other dangerous substances;

wastes from paint or varnish removal containing organic solvents or other dangerous substances;

synthetic engine, gear and lubricating oils;

fuel oil waste and diesel waste;

waste water containing oil or other hazardous substances;

discarded equipment, electronic components or electronic equipment containing electronic components (except for circuit boards not containing hazardous substances exceeding hazardous waste thresholds);

all types of oil waste;

battery, accumulator waste;

battery, lead accumulator waste;

fluorescent tube and types of activated glass waste;

rubber waste;

hard metal packaging waste including completely empty pressure container;

disposed absorbents, filtering materials (including oil filtering materials), rags, protection fabric contaminated with hazardous elements;

discarded equipment containing hazardous components (except for circuit boards not containing hazardous substances exceeding hazardous waste thresholds);

carbon-based linings and refractory materials originated from the metallurgical process containing hazardous substances;

linings and refractory materials with hazardous substances not originated from the metallurgical process;

other wastes containing hazardous organic substances;

wastes containing hazardous substances from exhaust gas treatment process;

infectious waste (including sharp waste);

emulsion and waste liquids not containing organic halogen waste from shaping process;

ferromagnetic powder solution;

disposed acid clorhidric;

other kinds of disposed acid;

disposed sodium hydroxide, ammonium hydroxide, potassium hydroxide and residues containing sodium hydroxide, ammonium hydroxide, potassium hydroxide;

disposed acid sulfuric;

pickling bases;

disposed printing ink box containing hazardous substances;

metal scrap mixed with oil or coal tar;

disposed thermal insulation materials containing asbestos;

not completely empty pressure containers;

broken, damaged or used devices containing mercury and heavy metals (thermometer, sphygmomanometer);

discarded electronic components or other electrical equipment having electronic components containing hazardous substances (except for circuit boards not containing hazardous substances exceeding hazardous waste thresholds);

discarded electronic components or other electrical equipment having electronic components (except for circuit boards not containing hazardous substances exceeding hazardous waste thresholds);

disposed flexible packaging;

shaping solution;

chemical container;

disposed chemicals and laboratory chemical mixtures having hazardous substances;

used catalyst containing transition metals or their compounds;

water waste having hazardous substances; and

other linings and refractory materials with hazardous substances originated from the metallurgical process.

In an embodiment disclosed, the induction heater 10 and associated components may be provided on a trailer, skid, or in a skid building or shipping container or shipping container frame, for example a DNV or ISO shipping container or shipping container frame.

In the preceding description, for purposes of explanation, numerous details are set forth in order to provide a thorough understanding of the embodiments. However, it will be apparent to one skilled in the art that these specific details are not required. In other instances, well-known structures are shown in block diagram form in order not to obscure the understanding.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. An induction heater for processing a feed material comprising:
a main tube having an internal conveyor, at least one of the main tube or conveyor providing an at least partly ferrous part;
one or more electric induction coils for heating the at least partly ferrous part to heat the feed material to provide heated outlet material; and
a conveyor drive for driving the conveyor.

2. The induction heater of claim 1, wherein the conveyor comprises a drag chain.

3. The induction heater of claim 1, wherein the conveyor is an auger, rotatable relative to the main tube by the conveyor drive.

4. An induction heater for processing a feed material comprising:
a rotatable main tube having an internal auger or flighting, at least one of the main tube or internal auger or flighting providing an at least partly ferrous part;
one or more electric induction coils for heating the at least partly ferrous part to heat the feed material to provide heated outlet material; and
a main tube drive for rotating the main tube.

5. The induction heater of claim 4, wherein the main tube and the internal auger or flighting are substantially ferrous.

6. The induction heater of claim 5, wherein the main tube and the internal auger or flighting are steel, stainless steel, or graphite.

7. The induction heater of claim 4, further comprising:
a gear crusher for crushing the feed material, the gear crusher comprising spaced-apart gears, at least one of the spaced-apart gears driven by a gear drive.

8. The induction heater of claim 6, wherein a gap between the spaced-apart gears is adjustable to provide an adjustable size for the crushed feed material, the particle size between a fine particle dust and a course shale.

9. The induction heater of claim 4, further comprising a stack adapted to vent or flare at least a portion of outlet vapors from the outlet material.

10. The induction heater of claim 4, further comprising a cooler adapted to cool outlet vapors from the outlet material.

11. The induction heater of claim 10, wherein the cooler comprises a condenser adapted to condense recovered water from the outlet vapors.

12. The induction heater of claim 4, further comprising a fire box adapted to cool outlet solids from the outlet material.

13. The induction heater of claim 4, further comprising a blower adapted to convey the outlet material from the main tube.

14. The induction heater of claim 4, further comprising a scrubber system adapted to clean outlet vapors from the outlet material.

15. The induction heater of claim 10, wherein the cooler comprises an air cooler, further comprising a blower adapted to provide ambient air to:
the air cooler;
a stack or chimney, at or near a base of the stack or chimney; or both.

16. The induction heater of claim 4, wherein the main tube comprises welded pipe or seamless pipe.

17. Induction heater of claim 4, further comprising one or more tumbler slats extending along and from an inner wall of the main tube to tumble the feed material.

18. A method of processing a feed material comprising:
conveying the feed material through a main tube having an internal conveyor, at least one of the main tube or the conveyor providing a ferrous part, the feed material conveyed through the main tube by the conveyor;
heating the feed material by induction heating of the ferrous part, at least a portion of the feed material and at least a portion of the ferrous part in contact, wherein the feed material is heated to provide a heated outlet material.

19. The method of claim 18, wherein the conveying comprises rotating or tumbling the feed material.

20. The method of claim 18, wherein the conveyor comprises an internal auger or flighting, and wherein the conveying comprises relative rotation between the conveyor and the main tube.

21. The method of claim 18, wherein the conveyor comprises an internal auger or flighting, and wherein the internal auger or flighting and the main tube are connected, and wherein the conveying comprises rotating the internal auger or flighting and the main tube together.

22. The method of claim 21, wherein the internal auger or flighting and the main tube are ferrous.

23. The method of claim 18, further comprising crushing the feed material prior to heating the feed material.

24. The method of claim 18, wherein the outlet material has a lower moisture content than the feed material.

25. The method of claim 18, wherein the feed material contains polychlorinated biphenyl (PCB), wherein the feed material is heated up to at least 2150 degrees Fahrenheit for a period of time, to remove the PCBs from the feed material.

26. The method of claim 18, further comprising recovering outlet vapors from the main tube.

27. The method of claim 26, wherein the outlet vapors are burned to generate electricity to at least partially supply the induction heating.

28. The method of claim 18, wherein the feed material comprises drilling cuttings.

29. The method of claim 18, wherein the feed material comprises gravel.

30. The method of claim 18, wherein the feed material is selected from the group of geologic material, hazardous waste, and organic waste.
